(19) United States
(12) Patent Application Publication
(10) Pub. No.: US 2026/0019841 A1
(43) Pub. Date: Jan. 15, 2026

(54) SIDELINK BEAM RECOVERY

(71) Applicant: Apple Inc., Cupertino, CA (US)

(72) Inventors: Peng Cheng, Beijing (CN); Chunxuan Ye, San Diego, CA (US); Fangli Xu, Beijing (CN); Haijing Hu, Los Gatos, CA (US); Naveen Kumar R. PALLE VENKATA, San Diego, CA (US); Ping-Heng Kuo, London (GB); Ralf Rossbach, Munich (DE); Yuqin Chen, Beijing (CN); Zhibin Wu, Los Altos, CA (US)

(21) Appl. No.: 18/992,469

(22) PCT Filed: Jul. 14, 2023
(86) PCT No.: PCT/US23/27744

§ 371 Date: Jan. 8, 2025

Related U.S. Application Data
(60) Provisional application No. 63/389,757, filed on Jul. 15, 2022.

(51) Int. Cl. H04W 24/08; H04W 24/10; H04W 92/18

(52) U.S. Cl. CPC H04W 24/08; H04W 24/10; H04W 92/18

(57) ABSTRACT

Disclosed are methods, systems, and computer-readable media to perform operations including: detecting a failure of a sidelink beam of a sidelink interface used to communicate with a second UE, wherein the first UE and the second UE are served by a base station; responsive to detecting the beam failure, generating a report for the sidelink beam failure; and sending the beam failure report to the second UE or the base station.

### CROSS-REFERENCE TO RELATED APPLICATIONS

The present application claims priority to U.S. Prov. App. No. 63/389,757, filed on Jul. 15, 2022, entitled “SIDELINK BEAM RECOVERY,” which is incorporated herein by reference in its entirety.

### BACKGROUND

Wireless communication networks provide integrated communication platforms and telecommunication services to wireless user devices. Example telecommunication services include telephony, data (e.g., voice, audio, and/or video data), messaging, internet-access, and/or other services. The wireless communication networks have wireless access nodes that exchange wireless signals with the wireless user devices using wireless network protocols, such as protocols described in various telecommunication standards promulgated by the Third Generation Partnership Project (3GPP). Example wireless communication networks include time division multiple access (TDMA) networks, frequency-division multiple access (FDMA) networks, orthogonal frequency-division multiple access (OFDMA) networks, Long Term Evolution (LTE), and Fifth Generation New Radio (5G NR). The wireless communication networks facilitate mobile broadband service using technologies such as OFDM, multiple input multiple output (MIMO), advanced channel coding, massive MIMO, beamforming, and/or other features.

Frequency bands for 5G NR may be separated into two different frequency ranges. Frequency Range 1 (FR1) may include frequency bands operating in sub-6 GHz frequencies, some of which are bands that may be used by previous standards, and may potentially be extended to cover new spectrum offerings from 410 MHz to 7125 MHz. Frequency Range 2 (FR2) may include frequency bands from 24.25 GHz to 52.6 GHz. Bands in the millimeter wave (mmWave) range of FR2 may have smaller coverage but potentially higher available bandwidth than bands in the FR1.

In some wireless communications networks, a user equipment (UE) may communicate with another UE without having the communication routed through a network node, using what is referred to as sidelink communication. A transmitting UE that wants to initiate sidelink communication may determine the available resources (e.g., sidelink resources) and may select a subset of these resources to communicate with a receiving UE based on a resource allocation scheme. Existing protocols support sidelink communication using Mode 1 and Mode 2 resource allocation schemes. In Mode 1 resource allocation scheme (referred to as “Mode 1”), the resources are allocated by a network node for in-coverage UEs. In Mode 2 resource allocation scheme (referred to as “Mode 2”), the transmitting UE selects the sidelink resources (e.g., sidelink transmission resources).

### SUMMARY

This disclosure describes methods and systems for sidelink beam failure reporting, e.g., sidelink operating in FR2. The methods and systems can be used in scenarios where a first UE (e.g., a transmitter UE (TX UE)) is communicating via sidelink with one or more second UEs (e.g., receiver UEs (RX UEs)). The first and/or the second UEs may be served by a base station. In these methods and systems, an RX UE detects sidelink beam failure, and responsively generates a beam failure report (BFR). In one implementation, the RX UE provides the BFR to the TX UE via a (second) component carrier (CC) that is different from a (first) CC on which the UEs were initially communicating. This implementation can be used, for example, in scenarios where the UEs are configured to use sidelink carrier aggregation (CA). In another implementation, the RX UE provides the BFR to the serving base station via a Uu link with the base station. This implementation can be used, for example, in scenarios where the UEs are operating using Mode 1. In yet another implementation, the RX UE provides the BFR to the TX UE via a fallback beam. This implementation can be used, for example, in scenarios where the UEs are not configured to use sidelink CA.

In accordance with one aspect of the present disclosure, a method to be performed by a user equipment (UE) is disclosed. The method involves: detecting a failure of a sidelink beam of a sidelink interface used to communicate with a second UE, wherein the first UE and the second UE are served by a base station; responsive to detecting the beam failure, generating a report for the sidelink beam failure; and sending the beam failure report to the second UE or the base station.

The previously-described implementation is implementable using a computer-implemented method; a non-transitory, computer-readable medium storing computer-readable instructions to perform the computer-implemented method; and a computer system including a computer memory interoperably coupled with a hardware processor configured to perform the computer-implemented method or the instructions stored on the non-transitory, computer-readable medium. These and other implementations may each optionally include one or more of the following features.

In some implementations, detecting the failure of the sidelink beam involves: detecting a threshold number of beam failure instances of the sidelink beam before completion of a beam failure detection timer, where the beam failure detection timer is restarted upon detection of each beam failure instance.

In some implementations, the method further involves receiving, from the second UE or the base station, a beam failure configuration including at least one of: a list of candidate sidelink beams for recovery, wherein the list of candidate sidelink beams is specified per bandwidth part, per component carrier, or both; a predetermined threshold for detecting beam failure; or a configuration of a fallback beam.

In some implementations, the beam failure report includes an indication of at least one of the candidate sidelink beams.

In some implementations, the sidelink interface is configured to use carrier aggregation, and sending the beam failure report to the second UE or the base station involves: selecting, from a plurality of component carriers used for the carrier aggregation, at least one new component carrier different from an initial component carrier associated with the sidelink beam; and sending the beam failure report to the second UE via the at least one new component carrier.

In some implementations, selecting, from the plurality of component carriers used for the carrier aggregation, the at least one new component carrier involves: selecting the at least one new component carrier based on a predefined rule; or selecting the at least one new component carrier based on a determination that at least one measurement associated with the at least one new component carrier is greater than a predetermined threshold.

In some implementations, sending the beam failure report to the second UE or the base station involves sending the beam failure report to the base station via a Uu interface.

In some implementations, sending the beam failure report to the second UE or the base station involves: selecting a fallback beam from a plurality of candidate fallback beams; and sending the beam failure report to the second UE via the selected fallback beam.

In some implementations, selecting the fallback beam involves: determining a respective measurement value for each of one or more of the plurality of candidate fallback beams; and selecting the fallback beam based on a comparison of the respective measurement value for each of the one or more candidate fallback beams to a predetermined threshold.

In some implementations, the plurality of candidate fallback beams follow one of: (i) a fixed beam sweeping pattern in a single resource pool, or (ii) a respective single beam pattern in each of a plurality of resource pools.

In some implementations, the single resource pool or at least one of the plurality of resource pools is a configured exceptional pool.

In some implementations, sending the beam failure report to the second UE or the base station involves: determining if the sidelink interface is configured to use carrier aggregation; and responsive to determining that the sidelink interface is not configured to use carrier aggregation, sending the beam failure report to the base station via a Uu interface.

In some implementations, sending the beam failure report to the second UE or the base station involves: determining if a fallback beam is available for sending the beam failure report; and responsive to determining that a fallback beam is not available for sending the beam failure report, sending the beam failure report to the base station via a Uu interface.

In some implementations, sending the beam failure report to the second UE or the base station involves: generating a message that includes the beam failure report and at least one of: (i) carrier information, (ii) a candidate beam index for a candidate recovery beam, (iii) measurements for the candidate recovery beam, or (iv) a cast type.

In some implementations, the message is one of a PC5 Radio Resource Control (RRC) message, a medium access control (MAC) control element (CE), a cause value element in a Uu RRC message.

In some implementations, the Uu RRC message is SidelinkUEInformationNR.

In some implementations, during a Logical Channel Prioritization (LCP) procedure, the message is assigned a priority higher than any sidelink buffer status report (BSR) and lower than data from uplink (UL)-Common Control Channel (CCCH).

The details of one or more embodiments of these systems and methods are set forth in the accompanying drawings and the description below. Other features, objects, and advantages of these systems and methods will be apparent from the description and drawings, and from the claims.

### BRIEF DESCRIPTION OF THE FIGURES

FIG. 1 illustrates an example communication system that includes sidelink communications, according to some implementations.

FIG. 2 illustrates a flowchart for sidelink beam failure reporting, according to some implementations.

FIG. 3A and FIG. 3B illustrate example scenarios of an RX UE determining whether a beam failure has occurred, according to some implementations.

FIG. 4 illustrates an example of using a new component carrier for beam failure reporting, according to some implementations.

FIG. 5 illustrates an example of reporting a beam failure report to a base station via Uu, according to some implementations.

FIG. 6A, 6B illustrate examples of candidate fallback beams, according to some implementations.

FIG. 7 illustrates a flowchart of an example method, according to some implementations.

FIG. 8 illustrates a user equipment (UE), according to some implementations.

FIG. 9 illustrates an access node, according to some implementations.

### DETAILED DESCRIPTION

In line with the discussion above, a first user equipment (UE) may communicate with a second UE without having the communication routed through a network node, using what is referred to as sidelink communication. In this arrangement, the first UE communicates with the second UE via sidelink, and the second UE communicates with the network node through a link referred to as a Uu link. Currently, Third Generation Partnership Project (3GPP) technical specifications include procedures for beam failure recovery on the Uu link. However, the existing technical specifications do not address beam failure recovery on the sidelink, such as sidelink operating within FR2.

This disclosure describes methods and systems for sidelink beam failure reporting, e.g., sidelink operating in FR2. The methods and systems can be used in scenarios where a first UE (e.g., a TX UE) is communicating via sidelink with one or more second UEs (e.g., RX UEs). The first and/or the second UEs may be served by a base station. In these methods and systems, an RX UE detects sidelink beam failure, and responsively generates a beam failure report (BFR). In one implementation, the RX UE provides the BFR to the TX UE via a (second) component carrier (CC) that is different from a (first) CC on which the UEs were initially communicating. This implementation can be used, for example, in scenarios where the UEs are configured to use sidelink carrier aggregation (CA). In another implementation, the RX UE provides the BFR to the serving base station via a Uu link with the base station. This implementation can be used, for example, in scenarios where the UEs are operating using Mode 1. In yet another implementation, the RX UE provides the BFR to the TX UE via a fallback beam. This implementation can be used, for example, in scenarios where the UEs are not configured to use sidelink CA.

The disclosed methods and systems for sidelink beam failure reporting are different from existing beam failure reporting procedures for other types of links (e.g., Uu links). Unlike some of the existing procedures, the disclosed methods and systems are RX UE centric. Further, in the disclosed methods and systems, the RX UE may report the BFR to either the TX UE or the serving base station. Furthermore, the disclosed methods and systems account for the lack of Random Access Channel (RACH) procedure in sidelink and for scenarios where sidelink CA is not supported. Yet further, the disclosed methods and systems support scenarios where the RX UE is IDLE, INACTIVE, or out of coverage (OOC), and also support Mode 1 and Mode 2.

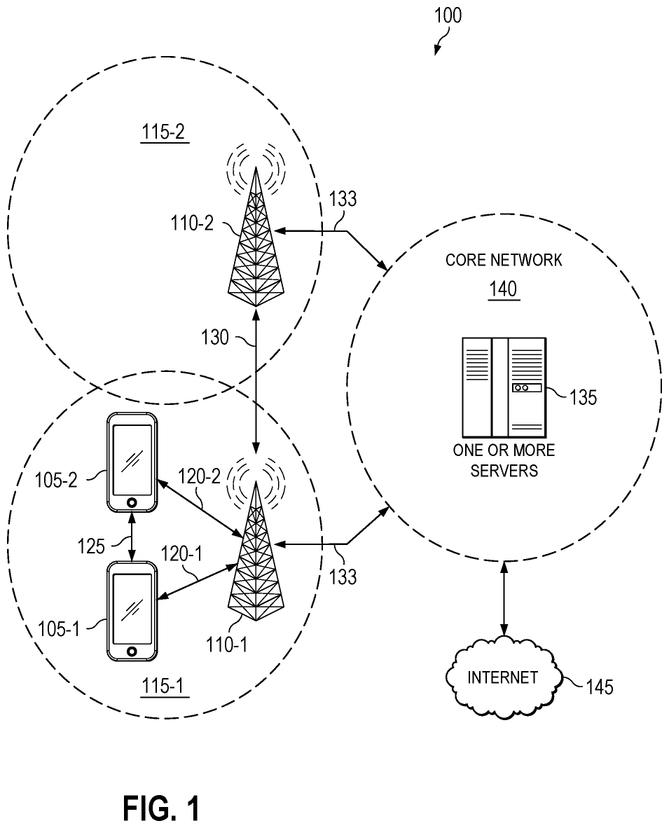

FIG. 1 illustrates an example communication system 100 that includes sidelink communications, according to some implementations. It is noted that the system of FIG. 1 is merely one example of a possible system, and that features of this disclosure may be implemented in other wireless communication systems.

The following description is provided for an example communication system that operates in conjunction with fifth generation (5G) networks as provided by 3GPP technical specifications. However, the example implementations are not limited in this regard, and the described examples may apply to other networks that may benefit from the principles described herein, such as 3GPP Long Term Evolution (LTE) networks, Wi-Fi networks, and the like. Furthermore, other types of communication standards are possible, including future 3GPP systems (e.g., Sixth Generation (6G) systems). While aspects may be described herein using terminology commonly associated with 5G NR, aspects of the present disclosure can be applied to other systems, such as 4G and/or systems subsequent to 5G (e.g., 6G).

As shown, the communication system 100 includes a number of user devices. More specifically, the communication system 100 includes two UEs 105 (UE 105-1 and UE 105-2 are collectively referred to as “UE 105” or “UEs 105”), two base stations 110 (base station 110-1 and base station 110-2 are collectively referred to as “base station 110” or “base stations 110”), two cells 115 (cell 115-1 and cell 115-2 are collectively referred to as “cell 115” or “cells 115”), and one or more servers 135 in a core network (CN) 140 that is connected to the Internet 145.

As shown, certain user devices may be able to conduct communications with one another directly, e.g., without an intermediary infrastructure device such as base station 110-1. In this example, UE 105-1 may conduct communications directly with UE 105-2. Similarly, the UE 105-2 may conduct communications directly with UE 105-1. Such peer-to-peer communications may utilize a “sidelink” interface such as a PC5 interface. In certain implementations, the PC5 interface supports direct cellular communication between user devices (e.g., between UEs 105), while the Uu interface supports cellular communications with infrastructure devices such as base stations. For example, the UEs 105 may use the PC5 interface for a radio resource control (RRC) signaling exchange between the UEs. The PC5/Uu interfaces are used only as an example, and PC5 as used herein may represent various other possible wireless communications technologies that allow for direct sidelink communications between user devices, while Uu in turn may represent cellular communications conducted between user devices and infrastructure devices, such as base stations.

To transmit/receive data to/from one or more base stations 110 or UEs 105, the UEs 105 may include a transmitter/receiver (or alternatively, a transceiver), memory, one or more processors, and/or other like components that enable the UEs 105 to operate in accordance with one or more wireless communications protocols and/or one or more cellular communications protocols. The UEs 105 may have multiple antenna elements that enable the UEs 105 to maintain multiple links 120 and/or sidelinks 125 to transmit/receive data to/from multiple base stations 110 and/or multiple UEs 105. For example, as shown in FIG. 1, UE 105-1 may connect with base station 110-1 via link 120 and simultaneously connect with UE 105-2 via sidelink 125.

The PC5 interface may alternatively be referred to as a sidelink interface and may include one or more logical channels, including but not limited to a Physical Sidelink Control Channel (PSCCH), a Physical Sidelink Shared Channel (PSSCH), a Physical Sidelink Discovery Channel (PSDCH), a Physical Sidelink Broadcast Channel (PSBCH), Physical Sidelink Feedback Channel (PSFCH), and/or any other like communications channels. The PSFCH carries feedback related to the successful or failed reception of a sidelink transmission. The PSSCH can be scheduled by sidelink control information (SCI) carried in the sidelink PSCCH. In some examples, the sidelink interface can operate on an unlicensed spectrum (e.g., in the unlicensed 5 Gigahertz (GHz) and 6 GHz bands) or a (licensed) shared spectrum.

In one example, the sidelink interface implements vehicle-to-everything (V2X) communications. The V2X communications may, for example, adhere to 3GPP Cellular V2X (C-V2X) specifications, or to one or more other or subsequent standards whereby vehicles and other devices and network entities may communicate. V2X communications may utilize both long-range (e.g., cellular) communications as well as short-to medium-range (e.g., non-cellular) communications. Cellular-capable V2X communications may be called Cellular V2X (C-V2X) communications. C-V2X systems may use various cellular radio access technologies (RATs), such as 4G LTE or 5G NR RATs (or RATs subsequent to 5G, e.g., 6G RATs). Certain LTE standards usable in V2X systems may be called LTE-Vehicle (LTE-V) standards. As used herein in the context of V2X systems, and as defined above, the term “user devices” may generally refer to devices that are associated with mobile actors or traffic participants in the V2X system, e.g., mobile (able-to-move) communication devices such as vehicles, pedestrian user equipment (PUE) devices, and roadside units (RSUs).

In some implementations, UEs 105 may be physical hardware devices capable of running one or more applications, capable of accessing network services via one or more radio links 120 with a corresponding base station 110 (also referred to as a “serving” base station), and capable of communicating with one another via sidelink 125. Link 120 may allow the UEs 105 to transmit and receive data from the base station 110 that provides the link 120. The sidelink 125 may allow the UEs 105 to transmit and receive data from one another. The sidelink 125 between the UEs 105 may include one or more channels for transmitting information from UE 105-1 to UE 105-2 and vice versa and/or between UEs 105 and UE-type RSUs and vice versa.

In some implementations, the base stations 110 are capable of communicating with one another over a backhaul connection 130 and may communicate with the one or more servers 135 within the CN 140 over another backhaul connection 133. The backhaul connections can be wired and/or wireless connections.

In some implementations, the UEs 105 are configured to use a resource pool for sidelink communications. A sidelink resource pool may be divided into multiple time slots, frequency channels, and frequency sub-channels. In some examples, the UEs 105 are synchronized and perform sidelink transmissions aligned with slot boundaries. A UE may be expected to select several slots and sub-channels for transmission of the transport block. In some examples, a UE may use different sub-channels for transmission of the transport block across multiple slots within its own resource selection window.

In some implementations, the communication system 100 supports different cast types, including unicast, broadcast, and groupcast (or multicast) communications. Unicast refers to direction communications between two UEs. Broadcast refers to a communication that is broadcast by a single UE to a plurality of other UEs. Groupcast refers to communications that are sent from a single UE to a set of UEs that satisfy a certain condition (e.g., being a member of a particular group).

In some implementations, the UEs 105 are configured to implement a beam failure recovery procedure for sidelink. For the purposes of this disclosure, a UE that is initiating a communication with another UE is referred to as a transmitter UE (TX UE), and the UE receiving the communication is referred to as a receiver UE (RX UE). For example, UE 105-1 may be a TX UE, and UE 105-2 may be an RX UE. Further, although FIG. 1 illustrates a single TX UE communicating with a single RX UE, a TX UE may communicate with more than one RX UE via sidelink.

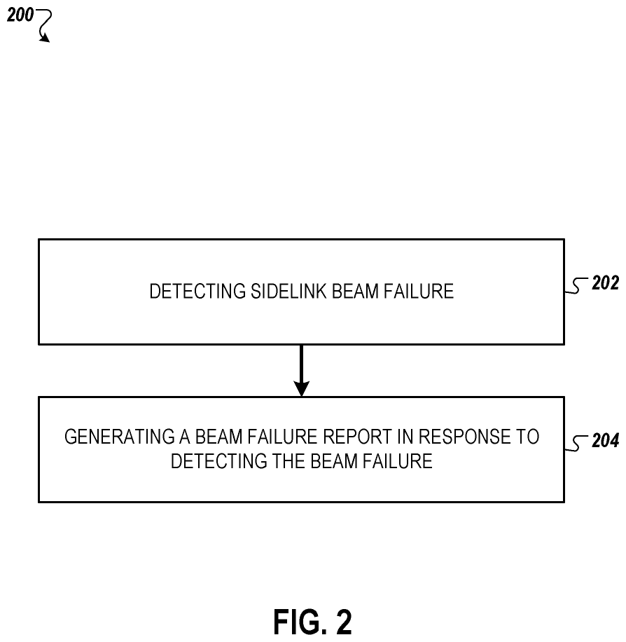

FIG. 2 illustrates a workflow 200 for sidelink beam failure reporting, according to some implementations. The workflow 200 can be implemented by an RX UE that is receiving (or scheduled to receive) a sidelink communication from a TX UE. The RX UE and the TX UE are served by a common base station (e.g., base station 110). The workflow 200 can be implemented by an RX UE operating in any RRC state, including idle, inactive, connected, or out of coverage (OOC). Furthermore, the workflow 200 can be implemented by an RX UE that is using Mode 1 or Mode 2 allocation scheme.

The workflow 200 starts at step 202. At step 202, the RX UE detects sidelink beam failure. In order to do so, the RX UE may be configured using a sidelink specific beam failure configuration. The beam failure configuration can be received via a message from the TX UE (e.g., via PC5 RRC) or from the base station (e.g., via RRC). Alternatively, the beam failure configuration can be pre-configured per resource pool. In one example, the beam failure configuration is received in a sidelink-specific RadioLinkMonitoringConfig message. The beam failure configuration can include a maximum number of beam failure instances, perhaps in an information element called beamFailureInstanceMaxCount. The beam failure configuration can also include a beam failure detection timer, perhaps in an information element called beamFailureDetectionTimer. Note that different beam failure detection timer values may be assigned to different RX UEs. The beam failure configuration can also include a list of beams for beam failure monitoring purposes. The list of beams can be identified using the sidelink Channel State Information (CSI) Reference Signals (CSI-RS) carried by the beams.

In some implementations, the RX UE is configured to detect a beam failure by comparing one or more measurements of one or more sidelink CSI-RS to a preconfigured threshold. Transmissions to the RX UE can include a CSI-RS for the RX UE to measure, and the RX UE can have periodic traffic and reserved periodic resources. The measurements can be Layer-1 Reference Signal Received Power (L1-RSRP) or Block Error Rate (BLER). In one example, the RX UE determines that a beam failure has occurred after detecting “N” continuous beam failures within a threshold period of time defined by the beam failure detection timer. In particular, the RX UE, perhaps in its Medium Access Control (MAC) layer, can maintain a sidelink specific beam failure instance (BFI) counter (e.g., called BFI_COUNTER). Additionally, for dynamic scheduling, the base station or the TX UE is configured to ensure that the beam failure detection timer covers at least one beam failure instance. That is, the base station is configured to ensure that the scheduled transmission is included in the configured beam failure monitoring pattern.

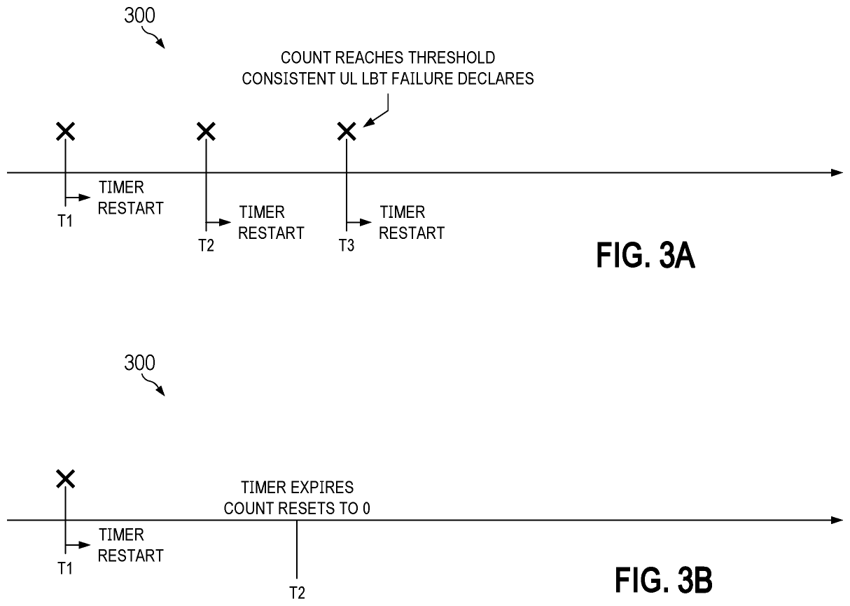

FIG. 3A and FIG. 3B illustrate example scenarios of an RX UE determining whether a beam failure has occurred, according to some implementations. In scenario 300 of FIG. 3A, the RX UE at time T1 detects a first instance of a beam failure. In response to detecting the instance, the RX UE resets a beam failure detection timer and increases the value of the sidelink BFI counter by 1. Then, at time T2, the RX UE detects a second instance of a beam failure. Here, like at T1, the RX UE resets a beam failure detection timer and increases the value of the sidelink BFI counter by 1. At time T3, the RX UE detects a third instance of a beam failure. Here, like at T1 and T2, the RX UE resets a beam failure detection timer and increases the value of the sidelink BFI counter by 1. However, in an example, the counter has now exceeded a predetermined threshold. In response, the RX UE determines that beam failure has occurred.

In scenario 320 of FIG. 3B, the RX UE at time T1 detects a first instance of a beam failure. In response to detecting the instance, the RX UE resets a beam failure detection timer and increases the value of the sidelink BFI counter by 1. However, in this scenario, the RX UE does not detect another beam failure instance until the timer expires. Accordingly, the RX UE determines that a beam failure has not occurred and resets the value of the sidelink BFI counter to 0.

In some implementations, in response to detecting a sidelink beam failure, the RX UE is configured to perform at least one of the following actions: (i) declaring a sidelink radio link failure (RLF), (ii) triggering an upper layer (e.g., the MAC layer) to run a keep-alive check, and/or (iii) reporting the failure information to the base station if the RX UE is in an RRC connected state. In order to report the failure information, a new cause of failure can be added to 3GPP technical specifications. The keep-alive check is a mechanism running in PCS-S. Under this mechanism, the TX UE will periodically send PCS-S signaling to check whether RX UE can respond, so that TX UE can determine whether the RX UE is operating (alive).

In some implementations, as shown in step 204 of FIG. 2, the RX UE generates a beam failure report in response to detecting the beam failure. More specifically, the RX UE is configured to generate and report the beam failure report using a sidelink specific beam failure reporting configuration. The beam failure reporting configuration can be received in a message from a TX UE (e.g., via PC5 RRC) or from a base station (e.g., via RRC). The beam failure reporting configuration message can be a sidelink specific BeamFailureRecoveryConfig message. Alternatively, the beam failure reporting configuration can be pre-configured per resource pool. In some examples, the beam failure reporting configuration can include a list of candidate beams for recovery. The list of candidate sidelink beams can be identified using sidelink CSI-RS or sidelink Synchronization Signal Block (SSB) carried by the sidelink beams. In some examples, the list of candidate beam may include beams per bandwidth part (BWP) and/or per CC.

In some implementations, the RX UE selects one or more of candidate beams for recovery from the list of candidate beams. The RX UE includes the one or more selected beams in the beam failure report. In the report, the RX UE can identify the one or more selected beams using a reference signal index. In one example, the RX UE selects the candidate beams based on a preconfigured threshold (e.g., L1-RSRP), which can be defined in the beam failure reporting configuration. In this example, the RX UE selects the candidate beams that have a measurement value greater than the preconfigured threshold. In another example, the RX UE selects a single candidate beam to include in the beam failure report. In this example, if there is more than one candidate beam that has a measurement value greater than the preconfigured threshold, then the RX UE selects the candidate beam based on RX UE implementation. In some examples, the failure reporting configuration also includes information on one or more fallback beams, which can be identified using CSI-RS or SL-SSB. The fallback beams are described in more detail below.

In some implementations, the RX UE is configured to select at least one of one or more options for reporting a beam failure report. The one or more options include: (i) reporting the beam failure report via a different CC than the CC on which the RX UE was communicating with the TX UE (e.g., in scenarios where the RX UE/TX UE are communicating using sidelink carrier aggregation), (ii) reporting the beam failure report to a base station via a Uu interface, and (iii) reporting the beam failure report via a fallback beam. Each of these options is described in more detail.

Turning to the first option, the RX UE can be configured to report a beam failure report to the TX UE via a CC different from the CC on which the RX UE was communicating with the TX UE before detecting beam failure. The UE RX can be configured to implement this option when PC5 CA is enabled. In this option, when sidelink beam failure is detected on an initial sidelink CC, the RX UE sends the beam failure report to the TX UE via another sidelink CC. The RX UE can send the beam failure report in a message, such as a MAC-Control Element (CE) or a PC5 RRC message. The MAC-CE and the PC5 RRC message are described in more detail below.

In some implementations, the RX UE is configured to select the CC on which to send the beam failure report to the TX UE. In one example, the RX UE selects the CC based on a predefined rule, such as a pre-configured CC by a base station or a peer UE (e.g., the TX UE), or an FR1 CC (e.g., if the initial CC was an FR2 CC). In another example, the RX UE selects the CC based on UE implementation. In this example, the RX UE selects the CC from one or more CCs that have a measurement value (e.g., RSRP) greater than or equal to a preconfigured threshold. In some examples, the RX UE can duplicate the sidelink beam failure report on a plurality of selected CCs.

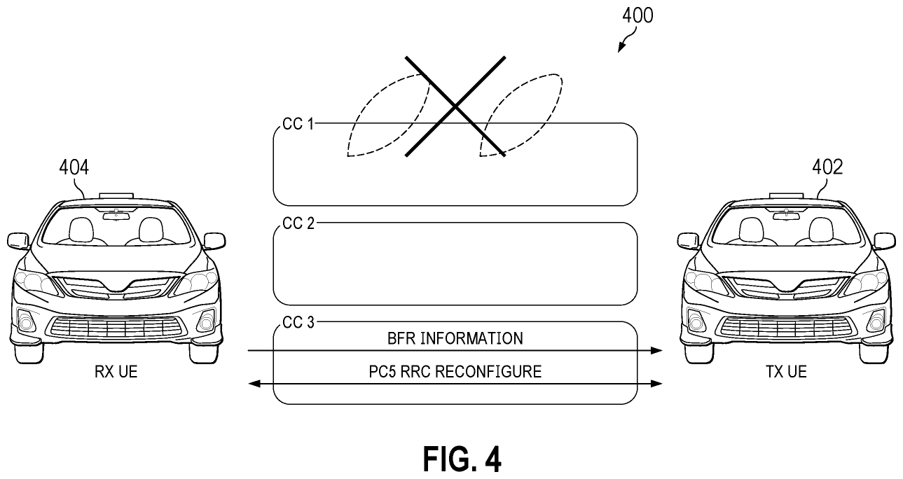

FIG. 4 illustrates an example 400 of using a new component carrier for beam failure reporting, according to some implementations. As shown in FIG. 4, a TX UE 402 and an RX UE 404 are configured to communicate using carrier aggregation that includes three component carriers: component carrier 1 (CC 1), component carrier 2 (CC 2), and component carrier 3 (CC 3). In this example, the TX UE 402 and the RX UE 404 are initially communicating on a component carrier 1. During the communications, the RX UE 404 detects a beam failure on the component carrier 1 and generates a beam failure report. In response to detecting the failure, the RX UE 404 is configured to send the beam failure report on a new component carrier that is different than the initial component carrier. In this example, the RX UE 404 selects component carrier 3 as the new component carrier over which the RX UE 404 provides the TX UE 402 with the beam failure report. In response to receiving the beam failure report, the TX UE 402 negotiates with the RX UE 404 on beam measurement/switching/reporting via PC5 RRC reconfiguration, physical layer signaling (e.g., SCI), or a sidelink MAC-CE.

In the second option, the RX UE reports the beam failure report to a serving base station via a Uu link. The RX UE can be configured to implement this option when operating in Mode 1 or Mode 2. In this option, in response to detecting beam failure, if the RX UE is not in an RRC connected state, the RX UE requests to enter the connected state for sidelink beam failure reporting. Once in the connected state, the RX UE can directly send the sidelink beam failure report to the base station via a Uu link. Based on the received sidelink beam failure report, the base station may reconfigure a resource pool for the TX and RX UEs. Alternatively, the base station may reconfigure the RX/TX UE beam measurement/switch/reporting via Uu RRC reconfiguration or via a Uu MAC-CE. This includes reconfiguration of beam transmission periodicity, frequency, and/or spatial resolution. Additionally and/or alternatively, it includes reconfiguration of reporting interval. Note that the RX UE may be configured not to select this option when the RX UE is out-of-coverage from the serving base station. Also note that although TX UE 402 and RX UE 404 are depicted in the form of vehicles, the TX UE 402 and RX UE 404 can take the form of other user equipment, such as those described in this disclosure (e.g., mobile phones).

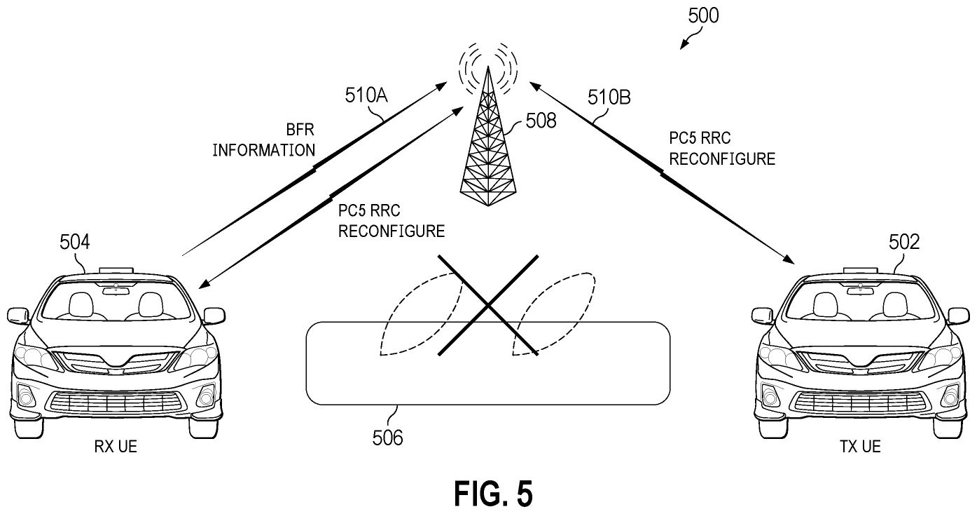

FIG. 5 illustrates an example 500 of reporting a beam failure report to a base station via Uu, according to some implementations. As shown in FIG. 5, a TX UE 502 and an RX UE 504 are initially communicating on sidelink 506. During the communications, the RX UE 504 detects a beam failure on the sidelink 506 and generates a beam failure report. In response to detecting the failure, the RX UE 504 is configured to send the beam failure report to a base station 508 on a Uu link 510A. In response to receiving the beam failure report, the base station 508 may reconfigure a resource pool for the TX and RX UEs via Uu links 510B, 510A, respectively. Alternatively, the base station 508 may reconfigure the RX/TX UE beam measurement/switch/reporting via Uu RRC reconfiguration or via a Uu MAC-CE. Note that although TX UE 502 and RX UE 504 are depicted in the form of vehicles, the TX UE 502 and RX UE 504 can take the form of other user equipment, such as those described in this disclosure (e.g., mobile phones).

In the third option, the RX UE reports the beam failure report to the TX UE via a fallback beam. The RX UE can be configured to implement this option when operating in Mode 1 or Mode 2. In this option, the RX UE is configured to select one or more CSI-RS or SL-SSB beams as fallback beams. As stated previously, the one or more fallback beams can be listed in the failure reporting configuration. In some instances, the one or more selected fallback beams may be wide beams (e.g., omnidirectional beams). In one example, the RX UE selects a fallback beam by comparing measurements of the fallback beams (e.g., RSRP) to a preconfigured threshold, and selecting the beam that is greater than the threshold. If more than one fallback beam can be selected, then the RX UE can be configured to select one of those beams based on UE implementation. Further, the TX UE is configured to select one or more RX beams via which to receive the one or more fallback beams based on UE implementation.

In one example, the one or more candidate fallback beams follow a fixed beam sweeping pattern in a single resource pool. In another example, the one or more candidate fallback beams follow a respective fixed beam pattern in a respective resource pool. In this example, multiple fallback beams can be configured in different resource pools. And in both examples, the resource pools for fallback beams can be an exceptional pool, which is a pool of resources reserved by the network for specified scenarios.

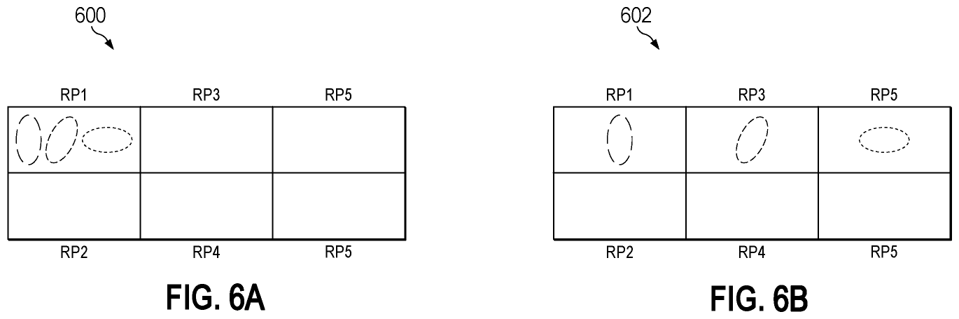

FIG. 6A, 6B illustrate examples 600, 602 of candidate fallback beams, according to some implementations. In FIG. 6A, the one or more candidate fallback beams follow a fixed beam sweeping pattern in a single resource pool, namely RP1. In FIG. 6B, the one or more candidate fallback beams follow a respective fixed beam pattern in a respective resource pool. In this example, multiple fallback beams can be configured in different resource pools. As shown in FIG. 6B, resource pools 1, 3, and 5 each include a respective fixed beam pattern for a candidate beam.

In some implementations, in response to detecting a sidelink beam failure, the RX UE is configured to start a timer. If at least one beam can be identified within a threshold period of time, then the RX UE sends the beam failure report to the TX UE via the identified beams. The RX UE then stops the timer. Based on receiving the beam failure report, the TX UE may negotiate with the RX UE on beam measurement/switching/reporting via PC5 RRC reconfiguration, physical layer signaling (e.g., SCI), or a sidelink MAC-CE. If the timer expires prior to the RX UE identifying a fallback beam, then the RX UE can declare radio link failure, and can implement the previously described steps that are performed after declaring radio link failure. More specifically, the RX UE triggers an upper layer (e.g., MAC) to run a keep-alive check. Then, the RX UE reports the failure information to the serving base station if the RX UE is in an RRC connected state. Alternatively, instead of immediately declaring radio link failure, the RX UE can attempt to re-transmit the sidelink beam failure report at least a threshold number of times before declaring radio link failure if none of the attempts are successful.

As stated previously, the beam failure report can be sent in a PC5 RRC message or in a sidelink MAC-CE. The sidelink MAC-CE can have a fixed Logical Channel ID (LCID). In some examples, the signaling to the TX UE can include at least one of: (i) carrier information, (ii) a beam index of candidate recovery beams (e.g., beams that have a measurement value greater than a threshold), (iii) available beam measurements, and/or cast type (e.g., broadcast, groupcast, unicast). Note that during a Logical Channel Prioritization (LCP) procedure, the priority of the MAC-CE is: data from SCCH>BFR failure MAC-CE>CSI reporting MAC-CE>data from STCH.

Furthermore, in examples example, the signaling of beam failure information towards gNB can be included in a new cause failure that can be sent in an Uu RRC message SidelinkUEInformationNR. In another example, the beam failure information can be carried in a sidelink MAC-CE that has a fixed LCID, a reserved LCID, or an eLCID. The sidelink MAC-CE can include at least one of: (i) carrier information, (ii) a beam index of candidate recovery beams (e.g., beams that have a measurement value greater than a threshold), (iii) available beam measurements, and/or cast type (e.g., broadcast, groupcast, unicast). Note that during an LCP procedure, the priority of the MAC-CE is greater than any SL-BSR and less than data from UL-CCCH. As an example, a priority during an LCP procedure described in 3GPP TS 38.321 V16.5.0 can be modified as follows (from high to low):
C-RNTI MAC CE or data from UL-CCCH;
Configured Grant Confirmation MAC CE or MAC CEs for BFR or Multiple Entry Configured Grant Confirmation MAC CE;
Sidelink BFR MAC CE;
Sidelink Configured Grant Confirmation MAC CE;
LBT failure MAC CE;
MAC CE for SL-BSR prioritized according to clause 5.22.1.6;
MAC CE for BSR, with exception of BSR included for padding;
Single Entry PHR MAC CE or Multiple Entry PHR MAC CE;
MAC CE for the number of Desired Guard Symbols;
MAC CE for Pre-emptive BSR;
MAC CE for SL-BSR, with exception of SL-BSR prioritized according to clause 5.22.1.6 and SL-BSR included for padding;
data from any Logical Channel, except data from UL-CCCH;
MAC CE for Recommended bit rate query;
MAC CE for BSR included for padding;
MAC CE for SL-BSR included for padding.

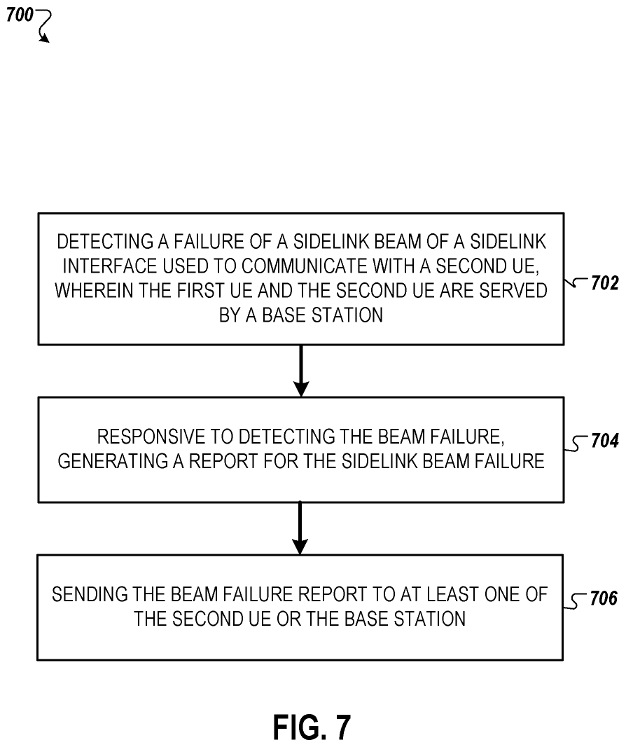

FIG. 7 illustrates a flowchart of an example method 700, according to some implementations. For clarity of presentation, the description that follows generally describes method 700 in the context of the other figures in this description. For example, method 700 can be performed by UE 105 of FIG. 1. It will be understood that method 700 can be performed, for example, by any suitable system, environment, software, hardware, or a combination of systems, environments, software, and hardware, as appropriate. In some implementations, various steps of method 700 can be run in parallel, in combination, in loops, or in any order.

At step 702, method 700 involves detecting a failure of a sidelink beam of a sidelink interface used to communicate with a second UE, where the first UE and the second UE are served by a base station.

At step 704, method 700 involves responsive to detecting the beam failure, generating a report for the sidelink beam failure.

At step 706, method 700 involves sending the beam failure report to the second UE or the base station.

In some implementations, detecting the failure of the sidelink beam involves: detecting a threshold number of beam failure instances of the sidelink beam before completion of a beam failure detection timer, where the beam failure detection timer is restarted upon detection of each beam failure instance.

In some implementations, method 700 further involves receiving, from the second UE or the base station, a beam failure configuration including at least one of: a list of candidate sidelink beams for recovery, wherein the list of candidate sidelink beams is specified per bandwidth part, per component carrier, or both; a predetermined threshold for detecting beam failure; or a configuration of a fallback beam.

In some implementations, the beam failure report includes an indication of at least one of the candidate sidelink beams.

In some implementations, the sidelink interface is configured to use carrier aggregation, and sending the beam failure report to the second UE or the base station involves: selecting, from a plurality of component carriers used for the carrier aggregation, at least one new component carrier different from an initial component carrier associated with the sidelink beam; and sending the beam failure report to the second UE via the at least one new component carrier.

In some implementations, selecting, from the plurality of component carriers used for the carrier aggregation, the at least one new component carrier involves: selecting the at least one new component carrier based on a predefined rule; or selecting the at least one new component carrier based on a determination that at least one measurement associated with the at least one new component carrier is greater than a predetermined threshold.

In some implementations, sending the beam failure report to the second UE or the base station involves sending the beam failure report to the base station via a Uu interface.

In some implementations, sending the beam failure report to the second UE or the base station involves: selecting a fallback beam from a plurality of candidate fallback beams; and sending the beam failure report to the second UE via the selected fallback beam.

In some implementations, selecting the fallback beam involves: determining a respective measurement value for each of one or more of the plurality of candidate fallback beams; and selecting the fallback beam based on a comparison of the respective measurement value for each of the one or more candidate fallback beams to a predetermined threshold.

In some implementations, the plurality of candidate fallback beams follow one of: (i) a fixed beam sweeping pattern in a single resource pool, or (ii) a respective single beam pattern in each of a plurality of resource pools.

In some implementations, the single resource pool or at least one of the plurality of resource pools is a configured exceptional pool.

In some implementations, sending the beam failure report to the second UE or the base station involves: determining if the sidelink interface is configured to use carrier aggregation; and responsive to determining that the sidelink interface is not configured to use carrier aggregation, sending the beam failure report to the base station via a Uu interface.

In some implementations, sending the beam failure report to the second UE or the base station involves: determining if a fallback beam is available for sending the beam failure report; and responsive to determining that a fallback beam is not available for sending the beam failure report, sending the beam failure report to the base station via a Uu interface.

In some implementations, sending the beam failure report to the second UE or the base station involves: generating a message that includes the beam failure report, the message further including at least one of: (i) carrier information, (ii) a candidate beam index for a candidate recovery beam, (iii) measurements for the candidate recovery beam, or (iv) a cast type.

In some implementations, the message is one of a PC5 Radio Resource Control (RRC) message, a medium access control (MAC) control element (CE), a cause value element in a Uu RRC message.

In some implementations, the Uu RRC message is SidelinkUEInformationNR.

In some implementations, during a Logical Channel Prioritization (LCP) procedure, the message is assigned a priority higher than any sidelink buffer status report (BSR) and lower than data from uplink (UL)-Common Control Channel (CCCH).

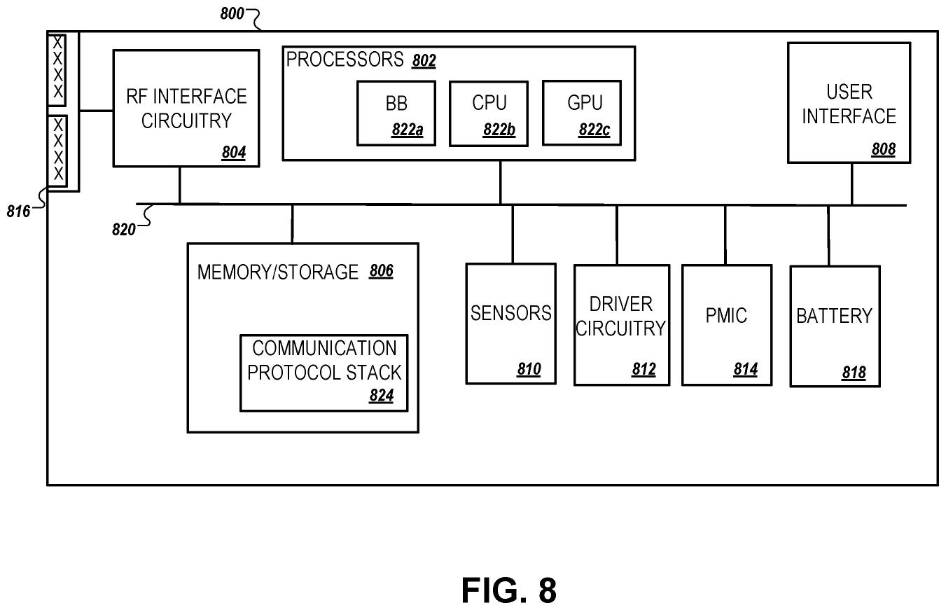

FIG. 8 illustrates a UE 800, according to some implementations. The UE 800 may be similar to and substantially interchangeable with UE 105 of FIG. 1.

The UE 800 may be any mobile or non-mobile computing device, such as, for example, mobile phones, computers, tablets, industrial wireless sensors (for example, microphones, pressure sensors, thermometers, motion sensors, accelerometers, inventory sensors, electric voltage/current meters, etc.), video devices (for example, cameras, video cameras, etc.), wearable devices (for example, a smartwatch), relaxed-IoT devices.

The UE 800 may include processors 802, RF interface circuitry 804, memory/storage 806, user interface 808, sensors 810, driver circuitry 812, power management integrated circuit (PMIC) 814, one or more antennas 816, and battery 818. The components of the UE 800 may be implemented as integrated circuits (ICs), portions thereof, discrete electronic devices, or other modules, logic, hardware, software, firmware, or a combination thereof. The block diagram of FIG. 8 is intended to show a high-level view of some of the components of the UE 800. However, some of the components shown may be omitted, additional components may be present, and different arrangements of the components shown may occur in other implementations.

The components of the UE 800 may be coupled with various other components over one or more interconnects 820, which may represent any type of interface, input/output, bus (local, system, or expansion), transmission line, trace, optical connection, etc. that allows various circuit components (on common or different chips or chipsets) to interact with one another.

The processors 802 may include processor circuitry such as, for example, baseband processor circuitry (BB) 822A, central processor unit circuitry (CPU) 822B, and graphics processor unit circuitry (GPU) 822C. The processors 802 may include any type of circuitry or processor circuitry that executes or otherwise operates computer-executable instructions, such as program code, software modules, or functional processes from memory/storage 806 to cause the UE 800 to perform operations as described herein.

In some implementations, the baseband processor circuitry 822A may access a communication protocol stack 824 in the memory/storage 806 to communicate over a 3GPP compatible network. In general, the baseband processor circuitry 822A may access the communication protocol stack to: perform user plane functions at a physical (PHY) layer, medium access control (MAC) layer, radio link control (RLC) layer, packet data convergence protocol (PDCP) layer, service data adaptation protocol (SDAP) layer, and PDU layer; and perform control plane functions at a PHY layer, MAC layer, RLC layer, PDCP layer, RRC layer, and a non-access stratum layer. In some implementations, the PHY layer operations may additionally/alternatively be performed by the components of the RF interface circuitry 804. The baseband processor circuitry 822A may generate or process baseband signals or waveforms that carry information in 3GPP-compatible networks. In some implementations, the waveforms for NR may be based on cyclic prefix orthogonal frequency division multiplexing (OFDM) “CP-OFDM” in the uplink or downlink, and discrete Fourier transform spread OFDM “DFT-S-OFDM” in the uplink.

In some implementations, the processors 802 are configured to detect a failure of a sidelink beam of a sidelink interface used to communicate with a second UE, wherein the first UE and the second UE are served by a base station; responsive to detecting the beam failure, generate a report for the sidelink beam failure; and send the beam failure report to the second UE or the base station.

The memory/storage 806 may include one or more non-transitory, computer-readable media that includes instructions (for example, communication protocol stack 824) that may be executed by one or more of the processors 802 to cause the UE 800 to perform various operations described herein. The memory/storage 806 includes any type of volatile or non-volatile memory that may be distributed throughout the UE 800. In some implementations, some of the memory/storage 806 may be located on the processors 802 themselves (for example, L1 and L2 cache), while other memory/storage 806 is external to the processors 802 but accessible thereto via a memory interface. The memory/storage 806 may include any suitable volatile or non-volatile memory such as, but not limited to, dynamic random access memory (DRAM), static random access memory (SRAM), erasable programmable read only memory (EPROM), electrically erasable programmable read only memory (EEPROM), Flash memory, solid-state memory, or any other type of memory device technology.

The RF interface circuitry 804 may include transceiver circuitry and radio frequency front module (RFEM) that allows the UE 800 to communicate with other devices over a radio access network. The RF interface circuitry 804 may include various elements arranged in transmit or receive paths. These elements may include, for example, switches, mixers, amplifiers, filters, synthesizer circuitry, control circuitry, etc.

In the receive path, the RFEM may receive a radiated signal from an air interface via one or more antennas 816 and proceed to filter and amplify (with a low-noise amplifier) the signal. The signal may be provided to a receiver of the transceiver that downconverts the RF signal into a baseband signal that is provided to the baseband processor of the processors 802.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna 816. In various implementations, the RF interface circuitry 804 may be configured to transmit/receive signals in a manner compatible with NR access technologies.

The antenna 816 may include antenna elements to convert electrical signals into radio waves to travel through the air and convert received radio waves into electrical signals. The antenna elements may be arranged into one or more antenna panels. The antenna 816 may have antenna panels that are omnidirectional, directional, or a combination thereof to enable beamforming and multiple input, multiple output communications. The antenna 816 may include microstrip antennas, printed antennas fabricated on the surface of one or more printed circuit boards, patch antennas, phased array antennas, etc. The antenna 816 may have one or more panels designed for specific frequency bands including bands in FR1 or FR2.

The user interface 808 includes various input/output (I/O) devices designed to enable user interaction with the UE 800. The user interface 808 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes “LEDs” and multi-character visual outputs), or more complex outputs such as display devices or touchscreens (for example, liquid crystal displays “LCDs,” LED displays, quantum dot displays, projectors, etc.), with the output of characters, graphics, multimedia objects, and the like being generated or produced from the operation of the UE 800.

The sensors 810 may include devices, modules, or subsystems whose purpose is to detect events or changes in their environment and send the information (sensor data) about the detected events to some other device, module, subsystem, etc. Examples of such sensors include, inter alia, inertia measurement units including accelerometers, gyroscopes, or magnetometers; microelectromechanical systems or nanoelectromechanical systems including 3-axis accelerometers, 3-axis gyroscopes, or magnetometers; level sensors; temperature sensors (for example, thermistors); pressure sensors; image capture devices (for example, cameras or lensless apertures); light detection and ranging sensors; proximity sensors (for example, infrared radiation detector and the like); depth sensors; ambient light sensors; ultrasonic transceivers; microphones or other like audio capture devices; etc.

The driver circuitry 812 may include software and hardware elements that operate to control particular devices that are embedded in the UE 800, attached to the UE 800, or otherwise communicatively coupled with the UE 800. The driver circuitry 812 may include individual drivers allowing other components to interact with or control various input/output (I/O) devices that may be present within, or connected to, the UE 800. For example, driver circuitry 812 may include a display driver to control and allow access to a display device, a touchscreen driver to control and allow access to a touchscreen interface, sensor drivers to obtain sensor readings of sensors 810 and control and allow access to sensors circuitry 810, drivers to obtain actuator positions of electro-mechanic components or control and allow access to the electro-mechanic components, a camera driver to control and allow access to an embedded image capture device, audio drivers to control and allow access to one or more audio devices.

The PMIC 814 may manage power provided to various components of the UE 800. In particular, with respect to the processors 802, the PMIC 814 may control power-source selection, voltage scaling, battery charging, or DC-to-DC conversion.

In some implementations, the PMIC 814 may control, or otherwise be part of, various power saving mechanisms of the UE 800. A battery 818 may power the UE 800, although in some examples the UE 800 may be mounted deployed in a fixed location, and may have a power supply coupled to an electrical grid. The battery 818 may be a lithium-ion battery, a metal-air battery, such as a zinc-air battery, an aluminum-air battery, a lithium-air battery, and the like. In some implementations, such as in vehicle-based applications, the battery 818 may be a typical lead-acid automotive battery.

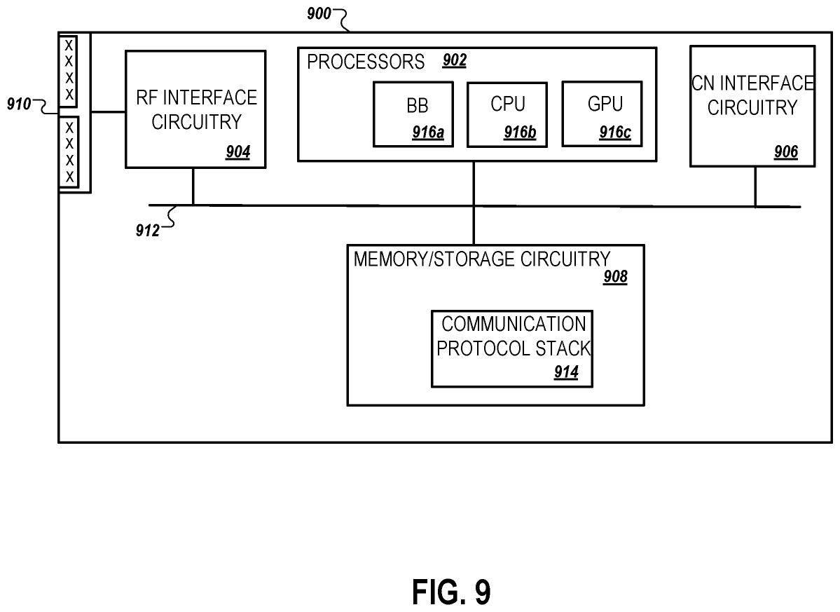

FIG. 9 illustrates an access node 900 (e.g., a base station or gNB), according to some implementations. The access node 900 may be similar to and substantially interchangeable with base station 110 of FIG. 1. The access node 900 may include processors 902, RF interface circuitry 904, core network (CN) interface circuitry 906, memory/storage circuitry 908, and one or more antennas 910.

The components of the access node 900 may be coupled with various other components over one or more interconnects 912. The processors 902, RF interface circuitry 904, memory/storage circuitry 908 (including communication protocol stack 914), one or more antennas 910, and interconnects 912 may be similar to like-named elements shown and described with respect to FIG. 8. For example, the processors 902 may include processor circuitry such as, for example, baseband processor circuitry (BB) 916A, central processor unit circuitry (CPU) 916B, and graphics processor unit circuitry (GPU) 916C.

The CN interface circuitry 906 may provide connectivity to a core network, for example, a 5th Generation Core network (5GC) using a 5GC-compatible network interface protocol such as carrier Ethernet protocols, or some other suitable protocol. Network connectivity may be provided to/from the access node 900 via a fiber optic or wireless backhaul. The CN interface circuitry 906 may include one or more dedicated processors or FPGAs to communicate using one or more of the aforementioned protocols. In some implementations, the CN interface circuitry 906 may include multiple controllers to provide connectivity to other networks using the same or different protocols.

As used herein, the terms “access node,” “access point,” or the like may describe equipment that provides the radio baseband functions for data and/or voice connectivity between a network and one or more users. These access nodes can be referred to as BS, gNBs, RAN nodes, eNBs, NodeBs, RSUs, TRxPs or TRPs, and so forth, and can include ground stations (e.g., terrestrial access points) or satellite stations providing coverage within a geographic area (e.g., a cell). As used herein, the term “NG RAN node” or the like may refer to an access node 900 that operates in an NR or 5G system (for example, a gNB), and the term “E-UTRAN node” or the like may refer to an access node 900 that operates in an LTE or 4G system (e.g., an eNB). According to various implementations, the access node 900 may be implemented as one or more of a dedicated physical device such as a macrocell base station, and/or a low power (LP) base station for providing femtocells, picocells or other like cells having smaller coverage areas, smaller user capacity, or higher bandwidth compared to macrocells.

In some implementations, all or parts of the access node 900 may be implemented as one or more software entities running on server computers as part of a virtual network, which may be referred to as a CRAN and/or a virtual baseband unit pool (vBBUP). In V2X scenarios, the access node 900 may be or act as a “Roadside Unit.” The term “Roadside Unit” or “RSU” may refer to any transportation infrastructure entity used for V2X communications. An RSU may be implemented in or by a suitable RAN node or a stationary (or relatively stationary) UE, where an RSU implemented in or by a UE may be referred to as a “UE-type RSU,” an RSU implemented in or by an eNB may be referred to as an “eNB-type RSU,” an RSU implemented in or by a gNB may be referred to as a “gNB-type RSU,” and the like.

Various components may be described as performing a task or tasks, for convenience in the description. Such descriptions should be interpreted as including the phrase “configured to.” Reciting a component that is configured to perform one or more tasks is expressly intended not to invoke 35 USC § 112(f) interpretation for that component.

For one or more implementations, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, network element, etc., as described above in connection with one or more of the preceding figures may be configured to operate in accordance with one or more of the examples set forth below in the example section.

Any of the above-described examples may be combined with any other example (or combination of examples), unless explicitly stated otherwise. The foregoing description of one or more implementations provides illustration and description, but is not intended to be exhaustive or to limit the scope of implementations to the precise form disclosed. Modifications and variations are possible in light of the above teachings or may be acquired from practice of various implementations.

Although the implementations above have been described in considerable detail, numerous variations and modifications will become apparent to those skilled in the art once the above disclosure is fully appreciated. It is intended that the following claims be interpreted to embrace all such variations and modifications.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

For one or more embodiments, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below.

### EXAMPLES

In the following section, further exemplary embodiments are provided.

Example 1 includes one or more processors of a first user equipment (UE), the one or more processors configured to perform operations including: detecting a failure of a sidelink beam of a sidelink interface used to communicate with a second UE, wherein the first UE and the second UE are served by a base station; responsive to detecting the beam failure, generating a report for the sidelink beam failure; and sending the beam failure report to the second UE or the base station.

Example 2 is the one or more processors of Example 1, wherein detecting the failure of the sidelink beam includes: detecting a threshold number of beam failure instances of the sidelink beam before completion of a beam failure detection timer, wherein the beam failure detection timer is restarted upon detection of each beam failure instance.

Example 3 is the one or more processors of any of Examples 1-2, the operations further including: receiving, from the second UE or the base station, a beam failure configuration including at least one of: a list of candidate sidelink beams for recovery, wherein the list of candidate sidelink beams is specified per bandwidth part, per component carrier, or both; a predetermined threshold for detecting beam failure; or a configuration of a fallback beam.

Example 4 is the one or more processors of Example 3, wherein the beam failure report including an indication of at least one of the candidate sidelink beams.

Example 5 is the one or more processors of any of Examples 1-4, wherein the sidelink interface is configured to use carrier aggregation, and wherein sending the beam failure report to the second UE or the base station includes: selecting, from a plurality of component carriers used for the carrier aggregation, at least one new component carrier different from an initial component carrier associated with the sidelink beam; and sending the beam failure report to the second UE via the at least one new component carrier.

Example 6 is the one or more processors of Example 5, wherein selecting, from the plurality of component carriers used for the carrier aggregation, the at least one new component carrier includes: selecting the at least one new component carrier based on a predefined rule; or selecting the at least one new component carrier based on a determination that at least one measurement associated with the at least one new component carrier is greater than a predetermined threshold.

Example 7 is the one or more processors of any of Examples 1-4, wherein sending the beam failure report to the second UE or the base station includes: sending the beam failure report to the base station via a Uu interface.

Example 8 is the one or more processors of any of Examples 1-4, wherein sending the beam failure report to the second UE or the base station includes: selecting a fallback beam from a plurality of candidate fallback beams; and sending the beam failure report to the second UE via the selected fallback beam.

Example 9 is the one or more processors of Example 8, wherein selecting the fallback beam includes: determining a respective measurement value for each of one or more of the plurality of candidate fallback beams; and selecting the fallback beam based on a comparison of the respective measurement value for each of the one or more candidate fallback beams to a predetermined threshold.

Example 10 is the one or more processors of Example 8, wherein the plurality of candidate fallback beams follow one of: (i) a fixed beam sweeping pattern in a single resource pool, or (ii) a respective single beam pattern in each of a plurality of resource pools.

Example 11 is the one or more processors of Example 10, wherein the single resource pool or at least one of the plurality of resource pools is a configured exceptional pool.

Example 12 is the one or more processors of any of Examples 1-4, wherein sending the beam failure report to the second UE or the base station includes: determining if the sidelink interface is configured to use carrier aggregation; and responsive to determining that the sidelink interface is not configured to use carrier aggregation, sending the beam failure report to the base station via a Uu interface.

Example 13 is the one or more processors of any of Examples 1-4, wherein sending the beam failure report to the second UE or the base station includes: determining if a fallback beam is available for sending the beam failure report; and responsive to determining that a fallback beam is not available for sending the beam failure report, sending the beam failure report to the base station via a Uu interface.

Example 14 is the one or more processors of any of Examples 1-4, wherein sending the beam failure report to the second UE or the base station includes: generating a message that includes the beam failure report, the message further including at least one of: (i) carrier information, (ii) a candidate beam index for a candidate recovery beam, (iii) measurements for the candidate recovery beam, or (iv) a cast type.

Example 15 is the one or more processors of Example 14, wherein the message is one of a PC5 Radio Resource Control (RRC) message, a medium access control (MAC) control element (CE), a cause value element in a Uu RRC message.

Example 16 is the one or more processors of Example 15, wherein the Uu RRC message is SidelinkUEInformationNR.

Example 17 is the one or more processors of Example 14, wherein, during a Logical Channel Prioritization (LCP) procedure, the message is assigned a priority higher than any sidelink buffer status report (BSR) and lower than data from uplink (UL)-Common Control Channel (CCCH).

Example 18 may include a non-transitory computer storage medium encoded with instructions that, when executed by one or more computers, cause the one or more computers to perform the operations of any of examples 1-17, or any other method or process described herein.

Example 19 may include a system including one or more computers and one or more storage devices on which are stored instructions that are operable, when executed by the one or more computers, to cause the one or more computers to perform the operations of any of examples 1-17, or any other method or process described herein.

Example 20 may include a method for performing the operations of any of examples 1-17.

Example 21 may include an apparatus including logic, modules, or circuitry to perform one or more elements of the operations described in or related to any of examples 1-17, or any other operations or process described herein.

Example 22 may include a method, technique, or process as described in or related to the operations of any of examples 1-17, or portions or parts thereof.

Example 23 may include an apparatus including: one or more processors and one or more computer-readable media including instructions that, when executed by the one or more processors, cause the one or more processors to perform the method, techniques, or process as described in or related to the operations of any of examples 1-17, or portions thereof.

Example 24 may include a signal as described in or related to any of examples 1-17, or portions or parts thereof.

Example 25 may include a datagram, information element, packet, frame, segment, PDU, or message as described in or related to any of examples 1-17, or portions or parts thereof, or otherwise described in the present disclosure.

Example 26 may include a signal encoded with data as described in or related to any of examples 1-17, or portions or parts thereof, or otherwise described in the present disclosure.

Example 27 may include a signal encoded with a datagram, IE, packet, frame, segment, PDU, or message as described in or related to any of examples 1-17, or portions or parts thereof, or otherwise described in the present disclosure.

Example 28 may include an electromagnetic signal carrying computer-readable instructions, wherein execution of the computer-readable instructions by one or more processors is to cause the one or more processors to perform the method, techniques, or process as described in or related to the operations of any of examples 1-17, or portions thereof.

Example 29 may include a computer program including instructions, wherein execution of the program by a processing element is to cause the processing element to carry out the method, techniques, or process as described in or related to the operations of any of examples 1-17, or portions thereof. The operations or actions performed by the instructions executed by the processing element can include the operations of any one of examples 1-17.

Example 30 may include a signal in a wireless network as shown and described herein.

Example 31 may include a method of communicating in a wireless network as shown and described herein.

Example 32 may include a system for providing wireless communication as shown and described herein. The operations or actions performed by the system can include the operations of any one of examples 1-17.

Example 33 may include a device for providing wireless communication as shown and described herein. The operations or actions performed by the device can include the operations of any one of examples 1-17.

The previously-described operations of examples 1-17 are implementable using a computer-implemented method; a non-transitory, computer-readable medium storing computer-readable instructions to perform the computer-implemented method; and a computer system including a computer memory interoperably coupled with a hardware processor configured to perform the computer-implemented method or the instructions stored on the non- transitory, computer-readable medium.

A system, e.g., a base station, an apparatus including one or more baseband processors, and so forth, can be configured to perform particular operations or actions by virtue of having software, firmware, hardware, or a combination of them installed on the system that in operation causes or cause the system to perform the actions. The operations or actions performed either by the system can include the operations of any one of examples 1-17.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users of the examples set forth below in the example section.

1. One or more processors of a first user equipment (UE), the one or more processors configured to perform operations comprising:
detecting a failure of a sidelink beam of a sidelink interface used to communicate with a second UE, wherein the first UE and the second UE are served by a base station;
responsive to detecting a beam failure, generating a beam failure report; and
causing radio frequency (RF) circuity to send the beam failure report to the second UE or the base station.

2. The one or more processors of claim 1, wherein detecting the failure of the sidelink beam comprises:
detecting a threshold number of beam failure instances of the sidelink beam before completion of a beam failure detection timer, wherein the beam failure detection timer is restarted upon detection of each beam failure instance.

3. The one or more processors of claim 1, the operations further comprising:
causing the RF circuitry to receive, from the second UE or the base station, a beam failure configuration comprising at least one of:
a list of candidate sidelink beams for recovery, wherein the list of candidate sidelink beams is specified per bandwidth part, per component carrier, or both;
a predetermined threshold for detecting the beam failure; or
a configuration of a fallback beam.

4. The one or more processors of claim 3, wherein the beam failure report comprising an indication of at least one of the candidate sidelink beams.

5. The one or more processors of claim 1, wherein the sidelink interface is configured to use carrier aggregation, and wherein sending the beam failure report to the at least one of the second UE or the base station comprises:
selecting, from a plurality of component carriers used for the carrier aggregation, at least one new component carrier different from an initial component carrier associated with the sidelink beam; and
causing the RF circuitry to send the beam failure report to the second UE via the at least one new component carrier.

6. The one or more processors of claim 5, wherein selecting, from the plurality of component carriers used for the carrier aggregation, the at least one new component carrier comprises:
selecting the at least one new component carrier based on a predefined rule; or
selecting the at least one new component carrier based on a determination that at least one measurement associated with the at least one new component carrier is greater than a predetermined threshold.

7. The one or more processors of claim 1, wherein sending the beam failure report to the second UE or the base station comprises:
causing the RF circuitry to send the beam failure report to the base station via a Uu interface.

8. The one or more processors of claim 1, wherein sending the beam failure report to the second UE or the base station comprises:
selecting a fallback beam from a plurality of candidate fallback beams; and
causing the RF circuitry to send the beam failure report to the second UE via the selected fallback beam.

9. The one or more processors of claim 8, wherein selecting the fallback beam comprises:
determining a respective measurement value for each of one or more of the plurality of candidate fallback beams; and
selecting the fallback beam based on a comparison of the respective measurement value for each of the one or more candidate fallback beams to a predetermined threshold.

10. The one or more processors of claim 8, wherein the plurality of candidate fallback beams follow one of: (i) a fixed beam sweeping pattern in a single resource pool, or (ii) a respective single beam pattern in each of a plurality of resource pools.

11. The one or more processors of claim 10, wherein the single resource pool or at least one of the plurality of resource pools is a configured exceptional pool.

12. The one or more processors of claim 1, wherein sending the beam failure report to the second UE or the base station comprises:
determining if the sidelink interface is configured to use carrier aggregation; and
responsive to determining that the sidelink interface is not configured to use the carrier aggregation, causing the RF circuitry to send the beam failure report to the base station via a Uu interface.

13. The one or more processors of claim 1, wherein sending the beam failure report to the second UE or the base station comprises:
determining if a fallback beam is available for sending the beam failure report; and
responsive to determining that the fallback beam is not available for sending the beam failure report, causing the RF circuitry to send the beam failure report to the base station via a Uu interface.

14. The one or more processors of claim 1, wherein sending the beam failure report to the second UE or the base station comprises:
generating a message that includes the beam failure report and at least one of: (i) carrier information, (ii) a candidate beam index for a candidate recovery beam, (iii) measurements for the candidate recovery beam, or (iv) a cast type.

15. The one or more processors of claim 14, wherein the message is one of a PC5 Radio Resource Control (RRC) message, a medium access control (MAC) control element (CE), a cause value element in a Uu RRC message.

16. The one or more processors of claim 15, wherein the Uu RRC message is SidelinkUEInformationNR.

17. The one or more processors of claim 14, wherein, during a Logical Channel Prioritization (LCP) procedure, the message is assigned a priority higher than any sidelink buffer status report (BSR) and lower than data from uplink (UL)-Common Control Channel (CCCH).

18. A method comprising:
detecting a failure of a sidelink beam of a sidelink interface of a first user equipment (UE), wherein the sidelink interface is used to communicate with a second UE, wherein the first UE and the second UE are served by a base station;
responsive to detecting a beam failure, generating a beam failure report; and
sending the beam failure report to the second UE or the base station.

19. A first user equipment (UE) comprising one or more processors and memory storing instructions that are operable, when executed by the one or more processors, to cause the first UE to perform operations comprising:
detecting a failure of a sidelink beam of a sidelink interface, wherein the sidelink interface is used to communicate with a second UE, wherein the first UE and the second UE are served by a base station;
responsive to detecting a beam failure, generating a beam failure report; and
sending the beam failure report to the second UE or the base station.

20. The UE of claim 19, wherein detecting the failure of the sidelink beam comprises:
detecting a threshold number of beam failure instances of the sidelink beam before completion of a beam failure detection timer, wherein the beam failure detection timer is restarted upon detection of each beam failure instance.
